(19) United States
(12) Patent Application Publication
(10) Pub. No.: US 2019/0056288 A1
(43) Pub. Date: Feb. 21, 2019

(54) INTEGRATED CONTROL SYSTEM AND METHOD FOR ENVIRONMENTAL TESTING CHAMBER

(71) Applicant: Crystal Instruments Corporation, Santa Clara, CA (US)

(72) Inventors: James Q. Zhuge, Palo Alto, CA (US); Zhengge Tang, San Jose, CA (US)

(73) Assignee: Crystal Instruments Corporation, Santa Clara, CA (US)

(21) Appl. No.: 15/679,658

(22) Filed: Aug. 17, 2017

(51) Int. Cl. G01M 7/02

(52) U.S. Cl. CPC G01M 7/022; G05D 19/02

(57) ABSTRACT

An integrated controller for an environmental testing system simultaneously controls and synchronizes vibration, temperature, and humidity in an environment test chamber over a specified reliability test duration, and performs condition-based measurement and processing of vibration data obtained from the environment test chamber for one or more specified trigger conditions. The controller executes a combined run schedule using a single internal clock and a hardware processor, to generate parameter control commands for the environment test chamber that remain synchronized to the single internal clock over the duration of a test, even one that lasts for weeks or months. This permits multi-variate processing of measured instantaneous values of temperature, humidity, and vibration to obtain, e.g., condition-dependent vibration power spectra and averages for available conditions of temperature, humidity, or both.

### TECHNICAL FIELD

The present invention relates to control hardware providing control of an environment test chamber, and in particular for accurate control over one or more temperature, humidity, and vibration parameters in such test chambers.

### BACKGROUND ART

Environment test chambers simulate real-world environmental conditions to meet demanding environmental and reliability test requirements for a wide variety of aerospace, automotive, electronics, medical, commercial and test lab applications. For example, a test chamber may need to control all aspects of a combined vibration and temperature/humidity test regime, where temperature might need to range anywhere from −70° C. to 180° C., have a temperature ramp rate from 5° C. per minute to 15° C. per minute, and relative humidity from a very dry 10% or 20% up to humid conditions near 100%. The internal volume of such a test chamber would accommodate an electrodynamic shaker capable, for example, of delivering upwards of 400 kN of shaker force to a shake table that holds equipment being tested to create a specified vibration profile.

In the past, the vibration control portion is commonly provided by the shaker manufacturers who are specialized in vibration technology. The temperature and humidity controllers are usually provided by the chamber manufacturers who are skilled in temperature and humidity control. A chamber and shaker system that handles all three types of control can only be realized by interacting temperature/humidity controller and vibration controller. Software and hardware are all realized separately. Run schedules are realized on separate controllers and they are driven by their controllers' respective clocks. However, in conducting reliability tests in a test chamber with independent temperature, humidity, and vibration controls, it is not uncommon to run tests for as long as a few weeks or even months continuously. Run schedules are driven and counted based on an electrical clock of the corresponding controller hardware. If the clock reference crystal has an error of about 20 ppm, then even with a well-designed board layout this can amount to accumulated timing errors upwards of two seconds per day or one minute per month in any one of the controllers. Even when the temperature, humidity and vibration run schedules are initiated at the same time with a common command, the separate temperature, humidity, and vibration control signals, as well as the time stamps for the recorded measurement data, will gradually drift out of synchronization. With separate temperature, humidity, and vibration hardware processors, each driven by its own clock, control signals and test data will not line up correctly in the later stages of a long duration test. To avoid having interpretation of data being completely wrong, it is normal to have test protocols with built-in time margins around each specified test condition to account for the potential time drift in the separately controlled temperature, humidity and vibration run sequences. This need for a time margin or buffer surrounding each test condition increases the test durations, but also prevents certain kinds of multi-variate data analysis based on instantaneous conditions measurements.

Another major drawback of implementing the vibration controller and temperature/humidity controller separately is that it is not possible to realize a time-critical event driven actions on the vibration analysis. For example, it is common to request to save the vibration data at the instance when a variable derived from the temperature measurement is sharply rising or falling. The time control accuracy between such detection and when the data is saved must be within microseconds range. If the temperature/humidity controller is separated from that of vibration control or driven by separated clocks, as realized in the past, the delay of the data communication between multiple processors will make it impossible to realize such requirement.

If the vibration data processing is triggered based on purely temperature measurement, it is possible to realize it by feeding the temperature signal into the vibration controller as a measurement channel then triggers based on that. However, in the real world, the requirement may be more complex. Sometimes the vibration data processing is triggered based on more than a variable that is derived from the temperature control process (for example, a division between the temperature measurement and the output voltage that controls the cooling compressor, or an averaged temperature measurement signal where the average number depends on the change of control output). These derived variables are instantly available in the temperature controller, but take time to be transferred to the vibration controller.

### SUMMARY DISCLOSURE

An integrated controller for an environmental testing system is provided that is capable of simultaneously controlling and synchronizing the measurement of vibration, temperature, and humidity in an environment test chamber over a specified reliability test duration. Further, the controller can perform condition-based measurement and processing of vibration data obtained from the environment test chamber for one or more specified trigger conditions derived from the temperature control process. Still further, the controller permits time-critical multi-variate processing of measured instantaneous values of temperature, humidity, and vibration to obtain, e.g., condition-dependent vibration power spectra and averages for available conditions of temperature, humidity, or both. These capabilities are made possible in a controller that executes a combined run schedule using a single internal clock and a hardware processor, so as to generate parameter control commands for the environment test chamber that remain synchronized to the single internal clock over the duration of a test, even one that lasts for weeks or months.

In one embodiment of the invention, a method of simultaneously controlling and synchronizing the measurement of vibration, temperature, and humidity in an environment test chamber over a specified reliability test duration is provided. Schedules for respective vibration, temperature and humidity test parameters are integrated into a combined run schedule. The combined run schedule is executed based on a single internal clock and a hardware processor to generate parameter control commands to the environment test chamber. Measurements received from the environment test chamber are synchronized to the single internal clock over the duration of the combined run schedule.

In another embodiment of the invention, a method is provided for condition-based time-critical measurement and processing from a vibration, temperature and humidity controlled environment test chamber that is synchronized in the manner just described. Parameter control commands generated according to the integrated run schedule are provided to the environment test chamber. Temperature and humidity conditions and their derived variables in the chamber are monitored for the occurrence of one or more specified trigger conditions. Upon identifying such a trigger condition, within required time accuracy, vibration data is measured and recorded for a specified block of time or for as long as the condition prevails. Vibration data measured under each of the specified trigger conditions encountered during the test can then be processed and analyzed.

The specified trigger condition for initiating vibration data measurement and recording could be a “pre-trigger” condition wherein monitored temperature and humidity conditions are analyzed for trends to anticipate the likelihood of a trigger condition. In that case, measurement of the vibration data might be triggered or initiated upon the likelihood value obtained from the analysis exceeding some specified threshold. This use of trend analysis from the monitored conditions is helpful especially in cases where specified trigger conditions can be short-lived and might otherwise be missed.

In yet another embodiment, a method of analyzing vibration data obtained from a vibration, temperature, and humidity controlled environment test chamber is provided, wherein instantaneous values of temperature, humidity, and vibration are simultaneously measured. The ability to ensure synchronization of all the instantaneous data values enables the processing, for each available condition of temperature and humidity or both, or derived variables, of corresponding vibration data values, e.g. to obtain condition-dependent vibration power spectra and averages.

### BRIEF DESCRIPTION OF THE DRAWINGS

FIG. 1 is block diagram illustrating an integrated controller and environment test chamber system in accord with the present invention.

FIG. 2 is a plan view of a user interface display of a representative combined run schedule, in both a selected graphic view and a time-sequence list.

FIG. 3 is a schematic block diagram of a controller with trigger-conditioned recording of vibration data.

FIG. 4 is a graph of a sequence of triggered recording blocks of measured data during a test versus time.

FIG. 5 is a plan view of a user interface display of a representative set of limits for activating recording of data, here shown as a vibration spectrum versus frequency, in both graphical form and as a frequency-sequence list.

FIGS. 6 and 7 are graphical data displays of recorded vibration data based on instantaneous values of temperature and humidity measurement, where FIG. 6 is a 3D waterfall map with time, frequency and amplitude in the three axes, and where FIG. 7 is a corresponding color map with time and frequency in two axes and color (here shown in gray scale) representing magnitude.

### DETAILED DESCRIPTION

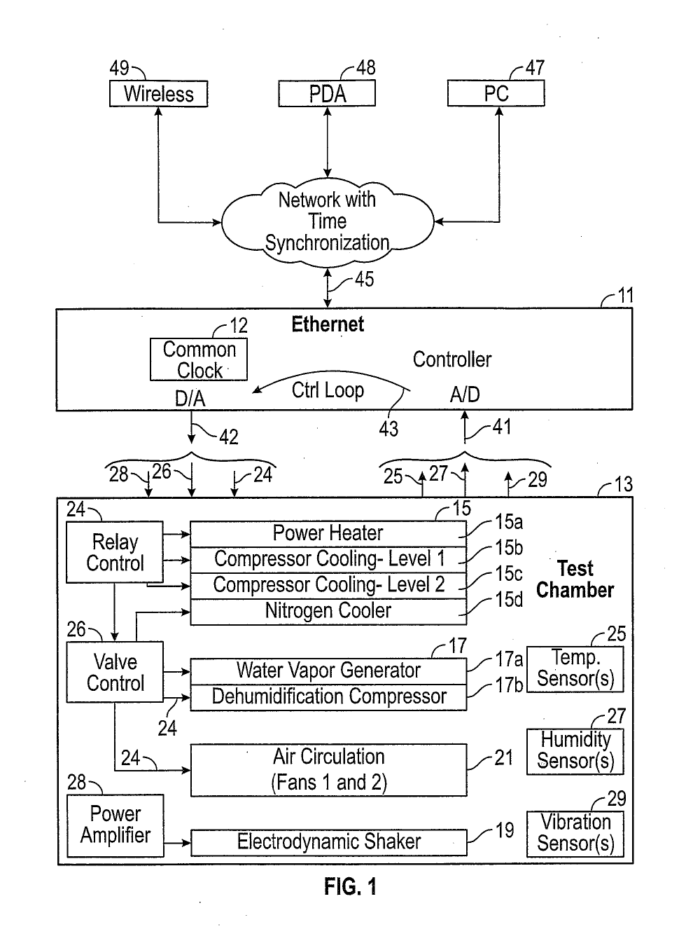

With reference to FIG. 1, a typical test setup comprises an integrated controller 11 and an environment test chamber 13. The environment test chamber 13 may be any of a wide variety of available test chamber systems, provided it is capable of accommodating vibration test equipment 19 therein with an appropriate shaker interface to the exterior of the chamber. Interior test chamber volumes could be 10 to 12 cubic meters or even larger, but could also be 10 to 20 times smaller, depending upon what kinds of units need to be tested. It will offer the capability of a combined temperature, humidity, and vibration test environment in a single test chamber system.

Temperature regulation 15 of the test chamber 13 will generally include both a heating system 15a and one or more cooling or refrigeration systems 15b-15d. The heating might be accomplished, for example, by means of high-power resistive wire heating, and preferably combined with one or more fans (part of air circulation system 21) for heat convection in the chamber. For cooling, any of a variety of refrigeration systems 15b-15c might be used, or even liquid nitrogen cooling 15d (or both) for very low temperature tests (e.g. near −70° C.). For example, vapor-compression refrigeration may be used. For even better performance and increased efficiency, a two-stage cascade refrigeration cycle (connected through a heat exchanger) might be employed. Better airflow (provided by efficient centrifugal fans) accelerate temperature changes. Test chambers that are capable of 15 to 20° C./minute average temperature ramp rates are available. Temperature control may include switching the resistive heater on/off via, e.g., a silicon control rectifier (SCR) switch, changing fan speed or the number of fans in operation, control of the refrigeration compressor(s) and expansion valve(s) configuration settings, and activation of any liquid nitrogen cooling (if provided). Temperature spatial uniformity and deviations within the chamber of not more than 2° C., together with temporal fluctuations of at most 0.5 to 1.0° C., are achievable.

Humidity regulation 79 of the test chamber 13 will generally include humidification and dehumidification subsystems 17a-17b. The humidifier 17a might inject steam into the chamber, where the steam might be obtained from a tank of purified water that is heated by a wire-heating furnace. Automated control of water delivery to the tank, water level in the tank (e.g. control of a valve at the bottom of the tank), and activation of the furnace heater, plus the rate of fan-based delivery 21 of the steam through air ducts to the chamber are all possible humidifier control options. Dehumidification 17b may be obtained by desiccation, wherein air is fed at a specified rate through a duct, then cooled to a desired dew point so that precipitated water can be removed before returning reheated (but now drier) air back into the chamber. Humidity deviations within the chamber of at most 5% RH and preferably less than 2% RH are achievable.

Vibration testing may be provided by a shaker table 19 that can be accommodated by the test chamber 13 and driven in one or more dimensions by electrodynamic shakers. The shaker system 15 may be water cooled to lessen the temperature control demands upon the test chamber from heat generated by the mechanical shaking itself. Shaker force may be upwards of 400 kN or possibly more for the larger test chambers, but could be 10- or 20-fold less forceful for small test chambers. Likewise, maximum displacement or slip size for the shaker table may be close to 2 meters for the larger test chambers, but less than 1 meter in small test chambers. The chamber-shaker interface maybe established, e.g., by direct connection with the shaker armature, by use of a shaft or plug connection between the chamber floor and the armature, or by interaction between a head expander of the shaker with the chamber.

Closed-loop control of the temperature, humidity and vibration is utilized, wherein signal acquisition from temperature, humidity and accelerometer sensors 25, 27 and 29 in the chamber 13 and shaker table 19 provide feedback to the integrated controller 11. The measured signals are compared to user-defined environment test conditions programmed prior to testing. Recognized deviations between actual and targeted values trigger control activation/deactivation signals based on adaptive PID control algorithms. For example, temperature control may involve activation or deactivation of components of the heating and cooling systems 15, such as by electrical relay control 24 with silicon-controlled rectifiers and/or valve control 26. This may include adjusting voltage/current inputs to the heater, runtime and performance of the refrigeration compressors and expansion valves, and opening/closing of the liquid nitrogen control valve. Likewise, for humidity 17, voltage/current inputs to the heating wire furnace of the humidifier water tank or triggering the dehumidifier compressor for a designated amount of time are two of the control options that may be available depending on the details of the test chamber. Various control mechanisms for the power amplifiers 28 driving the shake table 19 are available to produce desired shaking conditions, whether a sudden shock, swept sine vibration, random vibration profile, or other vibration waveform. For example, any one or more of the vibration control systems and methods that are described in U.S. Patent Application Publication 2010/0305886, and U.S. Pat. Nos. 8,942,930 and 9,317,044 could be employed.

The controller unit 11 may be configured for any of a variety of possible architectures, including older real-time PC-based architectures, or preferably either of the newer generation PC-tethered and networked architectures. In PC-based architectures a personal computer (PC) is part of the controller loop and data is transferred through a PC bus. All input samples are used to compute the drive signals with loop times as short as a fraction of a second. However, any disturbance in PC performance can have a direct impact on control. In PC-tethered architectures the PC is treated as an operator terminal with the capability of using the same input data for multiple tasks, including running multiple control loops for different frequency bands. Networked architectures are preferred. The PC becomes one of the operator terminals residing on a local area network (LAN) with high speed data communication and accurate time synchronization happening on the LAN. A user has a choice to access the controller through a PC, wireless, handheld pendant, PDA or other terminal residing on the LAN. The high-speed networked configuration has sub-microsecond time synchronization. A/D sensor inputs 41 and D/A control outputs 42 communicate with the controller unit 11, which internally provides the DSP control loop, while the controller unit 11 in turn communicates over an Ethernet 45 with any of various user operator terminals (e.g. PC 47, PDA 48, Wireless 49).

### Driven by the Same Clock

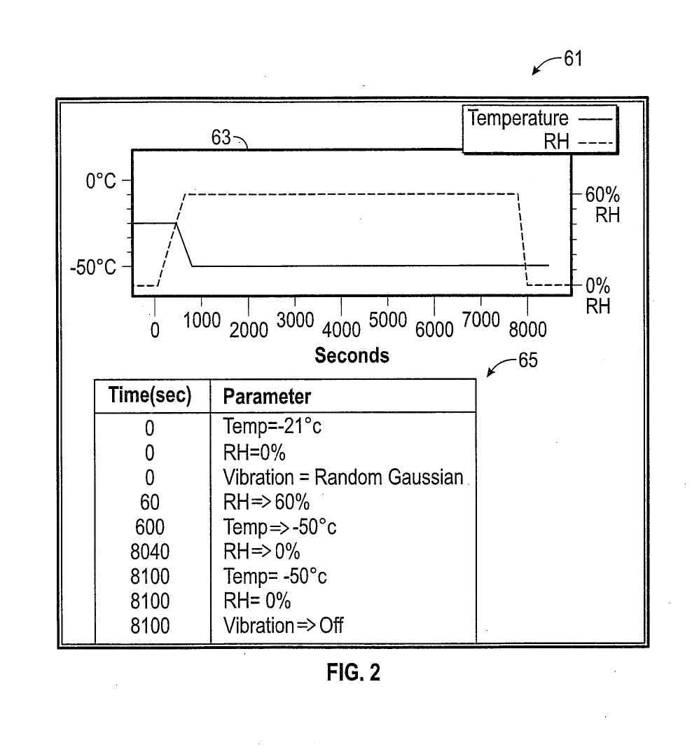

With reference to FIG. 2, three run-schedules, temperature, humidity, and vibration are run on the exact same clock internally. The controller unit 11 provides the common clock 12. Therefore, no time deviation will be generated, even after test durations of as long as a few weeks or even months continuously.

A typical target set up is like this: Test duration is specified, e.g. 8100 seconds. Temperature profile and parameters are set. This includes a set of times where temperature is scheduled to change, e.g. at time 0 seconds set temperature to −21° C.; at time 600 seconds change temperature to −50° C.; at end-of-test time 8100 seconds temperature remains at −50° C. This temperature profile for a test can be simple or complicated as desired. Temperature ramp rates, e.g. 10° C./min, can also be set for each scheduled temperature change. Other temperature parameters may include high and low alarm temperatures, and high and low test-abort temperatures, which could also vary at stages of a test. Humidity profile and parameters are set. As with temperature, this includes a set of times where relative humidity is scheduled to change, e.g. at time 0 seconds set humidity to 0% RH; at time 60 seconds increase humidity to 60% RH; at time 8040 seconds reduce humidity to 0% RH; at end-of-test time 8100 seconds humidity remains at 0% RH. Again, humidity profile for a test can be as simple or complicated as a user desires. Other humidity parameters may include high and low alarm values as well as high and low abort values. Temperature and humidity changes may be scheduled independently, so they can occur at different times or even at the same time for whatever test is desired. A set of vibration parameters for a test is scheduled, including the type(s) and magnitude(s) of shaking at various times, plus alarm and abort values for absolute or RMS acceleration and displacement limits. Random shaking can include distribution and kurtosis control, changes to which might also be scheduled for various times during the test. As with temperature and humidity control, the vibration parameters may be scheduled independently, so changes can occur at different times from those of temperature and humidity. Finally, it may be preferable in some tests to schedule any one or more of temperature, humidity, and vibration parameter changes for a certain subperiod (e.g. 180 seconds) less than the full test time (e.g. 8100 seconds), which can then be repeated multiple times (e.g. 45×) until the end of a test. This simplifies scheduling, since a user won't have to separately enter each periodic repetition of a sequence multiple times.

The three run schedules, even though they are set separately, are merged into a combined run schedule:

(Temperature Run Schedule+Humidity Run Schedule+Vibration Run Schedule)=Combined Run Schedule.

In FIG. 2, the user interface 61 may include a graph 63 displaying each (or selected ones) of the scheduled parameters over a test duration (or over a repeated subperiod), as well as a merged text list 65 of scheduled changes for the various times during a test.

The controller will accurately follow this schedule and, in the case of periodic schedules, cycle it thousands of times, as needed. If they were to be driven by different processors with different clocks, then after some certain time, the actual control between these targets will significantly deviate from one another on the time scale, which would make the test invalid. But, since a combined run schedule is initiated with one command, and then driven and counted based on a single common electrical clock on the hardware, then even after weeks or months later, all parts of the run schedule will still be accurately synchronized.

Vibration Data Processing Based on the Instantaneous Condition of Temperature and Humidity Measurement and their Derived Variables

In order to analyze the characteristics of mechanical units under the test, the vibration data measurement and processing may require very advanced algorithms. For example, in a typical test, any one or more of the following signal processing capabilities might be needed: data recording, digital filter, decimation filter, fast Fourier transform (FFT), auto-power spectrum, transfer function, coherence function, peak search, correlation analysis, fatigue damage spectrum, shock response spectrum and many more. These processing steps may be required on some occasions to be done at some pre-trigger condition of the temperature or humidity measurement or those computed values based on the input and output of temperature controller. “Pre-trigger condition” means that the signal processing described above are needed to apply to a short period of data just before such events happen. One example of a trigger includes one where the measured temperature or derived variables exceeds a certain preset value (or falls below a certain value). “Recording” is one simple type of data “processing” that the system could perform, and may be used to obtain a long period of data in case a trigger event happens. It is common to require that vibration processing applicable to the data triggered by the events of temperature and humidity within very high accuracy of time. Temperature can rise and fall very sharply within sub-second range. It is desired to capture and analyze the vibration data at microsecond time range when a temperature event happens. This can be realized by the digital signal processing software on one single processor, driven by the same clock and time base.

Recording with Trigger

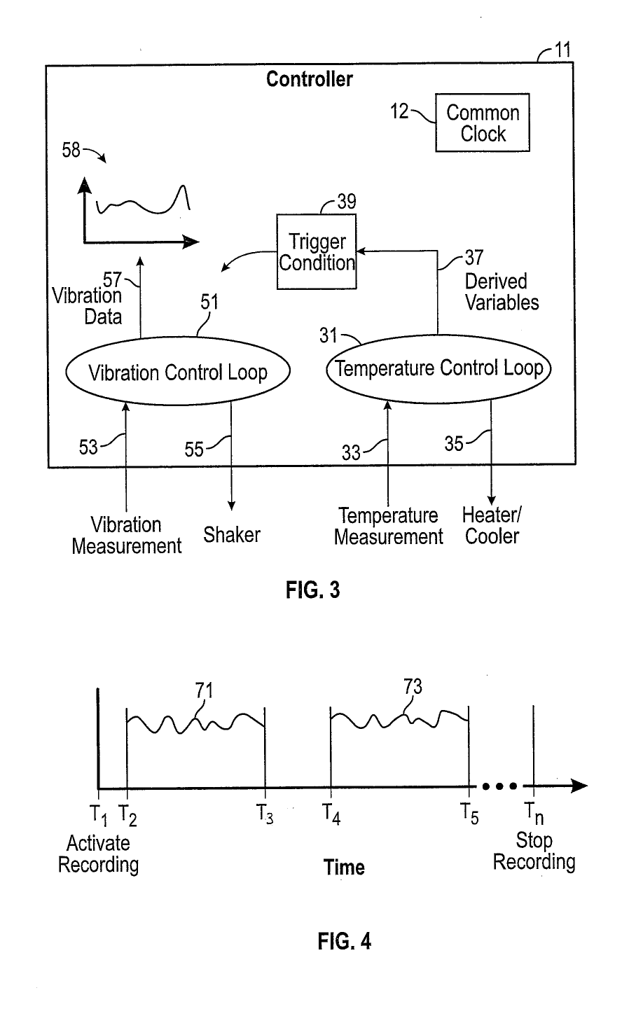

With reference to FIG. 3, having all control loops of the controller 11 and all measurements in digital format be accurately driven by the same clock 12 allows triggering of recording based on derived variables. For example, a temperature control loop 31 receives temperature measurements 33 and responds with appropriate heater/cooler command outputs 35. There is also a corresponding humidity control loop (not shown) structured in a substantially similar manner. Measurements 33 obtained from such control loops 31 can be used to derive other variables 37 therefrom, for example combining multiple measurement inputs into some kind measurement index or deriving rate of change of one or more measurements. Derived variables may take a certain processing time to calculate, but using the common clock 12 will be indexed to the measurement input times from which they are derived. A vibration control loop 51 is also provided for the shaker, and includes vibration measurements 53 and control outputs 55 to drive the shaker. The controller 11 monitors the temperature and other measurement inputs 33, and any derived variables therefrom, for the occurrence of certain trigger conditions 39. Upon identifying such a trigger condition 39, recording of vibration data 57 begins and can be processed to obtain processed vibration data 58 corresponding to that particular trigger condition 39.

Recording can automatically start and stop when time stream signals are triggered. This feature gives users a convenient way to monitor and record something unexpected. Users can set the time stream data in any channel on the master device as the trigger source and choose any trigger mode except Free Run mode to automatically activate the recording event. When the trigger mode is changed, the test will stop this run, and wait for user to begin a new run.

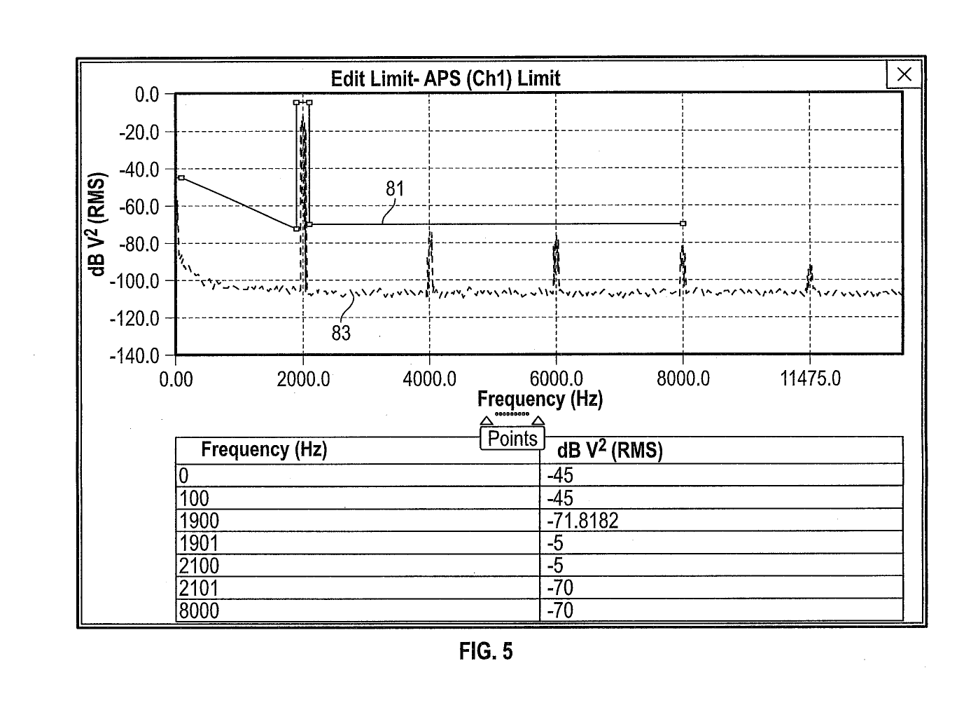

For example, as seen in FIG. 4, a series of recording blocks 71, 72 . . . , may be made of vibration data during a recording sequence activated by some trigger. Each recording block may have some specified time duration and may be repeated each time the trigger is set, up to some designated maximum number of times. If desired, different maximum numbers of times may be set for different types of triggers (where more than one kind of event can serve as a trigger).

For the Free Run mode, the trigger is not armed but the user can still preview the live signal and the trigger line to estimate the possible trigger event. Since the trigger event is not actually occurred, recording will not start under the Free Run mode.

For the continuous after trigger mode, the trigger will no longer be armed after it is triggered for the first time, so, if activated, the recording will only be activated once.

For the Single Shot by User mode, the system acquires one block every time the user presses the Run button, and it is not affected by the trigger signal, so that a recording event will not start under this mode.

For the manual-arm trigger, if the recording is activated, the first time it is triggered, the recording will start automatically. Users then need to either accept or reject the current trigger to prepare for the next recording trigger. If the running time stream on the back end is triggered again before users' action of accepting or rejecting the previous trigger, the recording will not start.

For the auto-arm trigger, the trigger arms automatically without users' input. If the recording is activated, the recording will start each time it is triggered. However, when the current recording is not finished, the new triggered event will not start another recording. Each independent recording cycle will not overlap with other recording cycles. For example, if the recording duration is 30 seconds, the other trigger event occurring during this recoding duration will not start another recording event.

When trigger is turned off during the running test, the test will continue to run without the trigger, and the recording will not be activated by any trigger.

When the input trigger is set to start a recording, the EDM has the option to repeat such recording for up to 100000 times. A “Recording is waiting on trigger” banner indicates that the recording sequence is activated. When the trigger signal comes in, the recording block will start for a certain duration defined and wait for another trigger signal to start another recording block. System actions such as stop recording button, stop test button, digital input, and limit exceeded event, will stop the recording sequence, therefore once the recording sequence is stopped, no new recording block will be added to the recording sequence, and the unused repeat times are forfeited.

Recording with Exceeding Limit

Recording can automatically start and stop when limits of either time stream, time block, or spectrum are exceeded. A signal exceeded event can be configured to start recording or stop recording. This is very useful when user wants to capture data when abnormal signals (exceeded signals) are observed. At any point when the signal exceeds a specified limit, the signal exceeded event occurs and will automatically start the data recording.

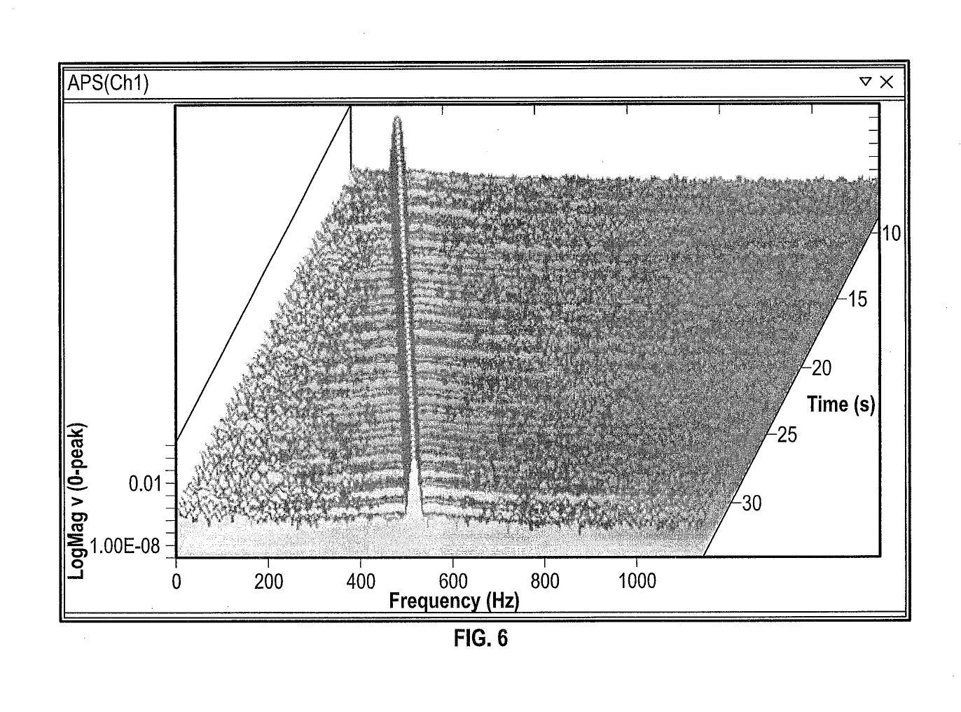

For example, as seen in FIG. 5, activation of recording may occur when the spectrum of the sensed vibrations 83 exceeds some limit 81, where different limits can be specified for different frequency bands. In the illustrated example, the limit is set to −5d B V² (RMS) between 1901 and 2100 Hz and it is seen that the sensed vibrations 83 do not exceed that limit, so there is no recording in this case. If it were to be exceeded, that would indicate an abnormal event that activates recording of the vibration data. Likewise, for any signal that might exceed −70 dB V²(RMS) at say 4000 Hz, or some other frequency, according to the user-specified limits.

Unlike the previously described trigger recording, there can be activation of recording for both a high limit and a low limit. When both limits are bound to the signal, the signal may exceed the high limit (above), exceed the low limit (below), or exceed both limits at different points in time. Limits can be bound to all time block signals, APS signals, FRF signals, time stream signals including peak and RMS stream.

The limit can be bound to any specified channel(s) on the system controller. When the limit exceeded event (spectrum or block) is set to start recording, the same event cannot be used to stop recording. So, the recording can be stopped by digital input, stop recording button, or stop test button.

When the record duration is set to zero, the recording will not stop unless the user or system action stops it. When the record duration is set to non-zero value, the recording will stop after the duration expires and immediately start another recording for the same duration. This will repeat until the user or system stops it. For example, if the record duration is set to 30 seconds, when the recording initially starts, after 150 seconds, there will be 5 recorded time data files, and each of them has 30-second data.

For an existing recording which was not started by the limit exceeded event, such an event can be set to stop recording by checking “when limit exceeded” under the stop recording event.

### Massive Vibration Data Storage and Display Based on the Instantaneous Value of Temperature and Humidity Measurement

In the test, it is common to be asked to store the vibration data based on the instantaneous value of temperature or humidity, or their derived variables, and average them. The vibration data capture and processing are simultaneously realized on the same processor that the temperature values are available. (It would not be feasible if the temperature data and vibration data were to be processed on different processors.)

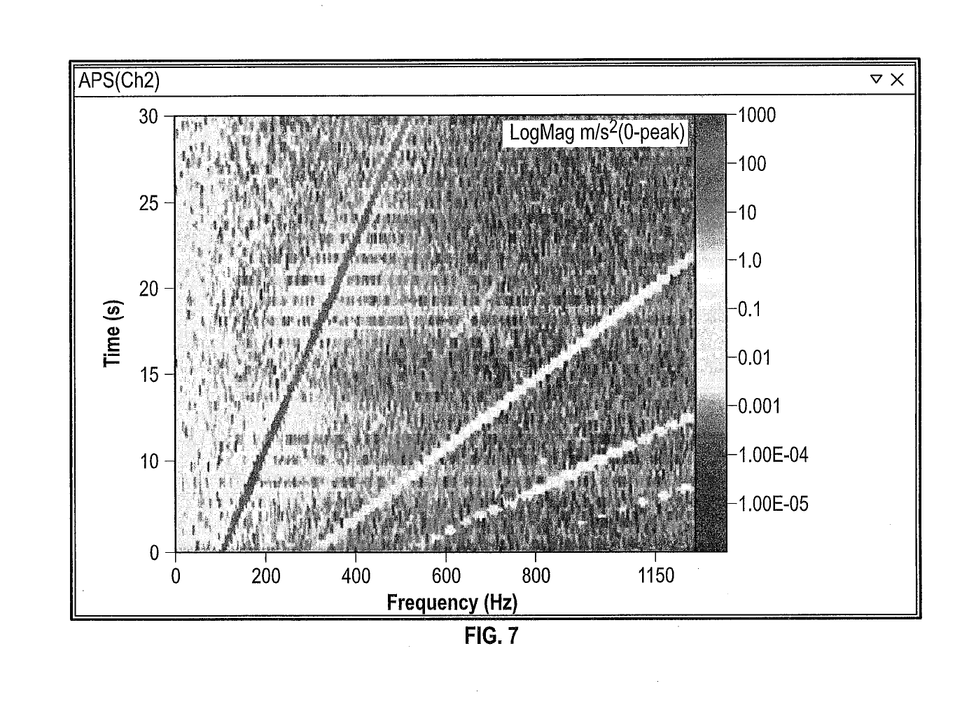

For example, a test may be set to run 5000 cycles between 0 C to 50 C, up and down, at 5 minutes per cycle. The user can ask the software to take the power spectrum of vibration data at each 1° C., and average the data taken among these 5000 cycles. Plots of waterfall or color maps can be generated, like those illustrated in FIGS. 6 and 7, wherein a waterfall map (e.g. FIG. 6) shows a 3D display with time on one axis, frequency on another, and amplitude in the third, and wherein a color map (e.g. FIG. 7) plots frequency in the horizontal axis, time in the vertical axis, and uses color to represent magnitude.

### Integrated Controller for Temperature, Humidity, and Vibration Control

A controller for environmental test chamber systems in accord with the present invention is designed specifically for precision temperature/humidity and vibration control in a combined temperature/humidity and vibration test regime, where a device under test (DUT) is subjected to simultaneous temperature cycling, variable humidity and vibration.

In a typical configuration, the controller may provide, e.g. four input channels (optionally expandable to eight) and two shaker drive outputs for shaker control. It may have inputs for two humidity sensors and eight thermocouples. Ten dedicated function switch closures may be provided to control the heaters, valves, and fans of the chamber. Eight pairs of programmable digital I/O may be available for user defined applications. However, it is configured, the controller will integrate and precisely control the temperature, humidity, and vibration sub-systems of an environment test chamber for a combined temperature/humidity and vibration testing system.

Likewise, data collection for atypical controller configuration may be accomplished using four analog input channels (expandable to eight) for vibration, eight 4-20 mA inputs for temperature, ten 4-20 mA inputs for humidity and twenty-four opto-isolated input channels. For sub-system control two output channels may be provided for vibration.

The exact number of the various kinds of control and data channels that are available in any particular controller can vary.

### Simple Network Connection

As seen in FIG. 1, Ethernet connectivity 45 allow controllers 11 to be located far from their host PC 47. This distributed structure greatly reduces noise and electrical interference in the system. A single PC 47 can monitor and control multiple controllers 11 over a network. Since the control processing and data recording are executed locally inside the controller 11, the network connection does not affect control reliability. With wireless network routers, a PC 47, PDA 48 or wireless terminal 49 connects easily to the controller 11 remotely via Wi-Fi.

Black Box mode enables controller operation without a PC. In this mode, a PC 47 is used only to configure the control system before the system starts operation and to download data after the test is completed. During the test, the controller 11 operates autonomously, according to a preset schedule or in response to a connected iPad.

Through a wireless connection between a user's iPad and any controller units on the wireless network, an iPad should allow engineers to monitor and control test settings and measurements, flip through existing measurement setups and past measurements runs, or create new test configurations from scratch. Using an iPad brings additional freedom to test engineers, making it possible to control any shaker table in the lab while walking around freely during a test monitoring signals on the iPad in real time.

A controller built with IEEE 1588 Precision Time Protocol (PTP) time synchronization technology allows controller modules on the same network to be synchronized within 50 ns accuracy, which will guarantee ±1° cross-channel phase match up to 20 kHz across the complete system. With such high-speed Ethernet data transfer, the distributed components on the network truly act as one integrated system.

### Vibration Control and Signal Analysis

Vibration control system (VCS) software provides a wide range of vibration and shock tests. Software solutions for vibration control can include Swept Sine, Resonance Search Track & Dwell (RSTD), Sine Oscillator, Random, Sine-on-Random (SoR), Random-on-Random (RoR), Swept Random-on-Random (SRoR), Classical Shock, Transient Time History (TTH), Seismic, Shock Response Spectrum (SRS) Synthesis, Time Waveform Replication, Highly Accelerated Life-Testing/Stress-Screening (HALT/HASS) and multi-drive control. These suites facilitate testing to virtually all current environmental test standards.

Random Vibration Control provides precise multichannel control in real time. The device under test is subjected to true random noise with a precisely shaped spectrum with either Gaussian or non-Gaussian amplitude statistics. With a control dynamic range up to 90 dB, multiple channels can be enabled for Control, Notching, Monitoring and time data recording. The recording option records time-stream data at the full sample rate on all input channels. A configuration featuring spectral overlapping can provide a fast loop time of less than 15 ms in a typical test.

Kurtosis control can provide a more damaging non-Gaussian random control time history. The controller can generate a non-Gaussian control time history while precisely maintaining its spectrum shape. Drive clipping clamps the drive signal to maximize the power rating of the power amplifier.

Non-linear control provides improved performance at frequencies near sharp resonances by using a unique error correction algorithm. Non-acceleration control allows measuring and controlling of physical measures other than acceleration. Displacement sensors and velocity sensors can be used together with accelerometers.

In random on random (RoR) control, multiple independent (stationary or sweeping) random narrow-band signals may be superimposed on the broadband random signal. Each narrow-band has its own sweeping schedule and range. They can be turned on and off by a predefined schedule or manually.

In sine on random (SoR) control, multiple independently sweeping sine tones may be controlled in addition to the broadband random signal. Each sine tone has its own sweeping schedule and range. Tones can be turned on and off manually or by a predefined schedule.

Swept Sine vibration control provides precise multichannel control in real time. It provides a spectrally pure undistorted sine wave and a control dynamic range of up to 100 dB. Multiple channels can be enabled for Control, Notching, Monitoring and time-data recording. The recording option records a time-stream at the full sample rate on all input channels. Spectral overlapping provides a fast loop time of less than 10 ms.

A random signal can be applied during pretest for checking the loop. Precise tracking filters are often applied to each channel with either fixed or proportional bandwidth. Spectral display resolution may range from 256 to 4096 lines.

Linear and logarithmic Sweep-speeds can be defined in Oct/Min, Hz/Sec, Dec/Min, Sweeps/Min, Sweep Time/Sweep or Cycles/Min. Non-acceleration control allows measuring and controlling on velocity or displacement sensors in lieu of acceleration. Multi-Drive control can drive more than one shaker. FRF measurement allows measuring the transmissibility between any channel-pair with high phase match. A frequency range up to at least 5 kHz and as much as 50 kHz may be provided. Notching, Alarm or Abort criteria can be set on each channel.

Step Sine control uses a sequence of short dwells within a frequency range. The steps are uniformly distributed in a log or linear frequency scale. Step Sine Entry in Run Schedule includes user defined frequency range, step resolution and dwell duration (or cycles) at each frequency.

Resonance Search and Tracked Dwell (RSTD) control function determines resonant frequencies from the peaks of a transmissibility signal. Dwell type (fixed dwell, tracked dwell, phase tracked dwell) may be specified manually (with a list of resonance frequencies) or automatically executed after a resonance search is done. Under real-time control, the tracked dwell entry tracks each resonant frequency as it shifts with time, temperature or damage. Phase Tracked Dwell allows tracking the resonance frequency by seeking both a peak transmissibility and a specified phase angle. Dwelling continues until time duration is reached or the resonance frequency changes outside of specified limits.

Total Harmonic Distortion (THD) Measurement for Sine adds the ability of computing Total Harmonic Distortion (THD) of the control and Input signals. THD plots can be generated while drive signal either steps through multiple discrete frequencies or a swept sine tone within a predefined range.

Classical Shock Control provides precise, real-time, multi-channel control and analysis of transient time domain motion. Classical pulse shapes include halfsine, haversine, terminal-peak sawtooth, initial-peak saw tooth, triangle, rectangle, and trapezoid. The recording option records time stream data at the full sample rate on all input channels. Shock response spectrum (SRS) analysis can be applied to any input signal; optionally control of the DUT's SRS may be executed. Applicable Test Standards include MIL-STD-810F, MIL-STD-202F, ISO 9568 and IEC 60068 (plus user-defined specifications).

Targeting seismic simulation applications, Transient Time History Control (TTH) controls shaker motion to match any user defined transient waveform. Time waveforms can be imported to EDM in various formats. Scaling, editing, digital re-sampling, highpass, low-pass filtering and compensation will tailor the waveform so that it may be duplicated on a particular shaker. Compensation varies the waveform so that it does not exceed the maximum shaker displacement. Methods include pre-pulse, post-pulse, pre-& post-pulse, DC removal and highpass filters. Pre-stored profiles include Bellcore Z1, Z2, Z3 and Z4; Sine; Chirp; Burst Sine and others. It might also run profiles requiring sampling frequency lower than 120 Hz. Large block sizes up to 64,000 samples may be provided. Shock Response Spectrum analysis can be applied to any input time signals to generate SRS instantaneously. SRS Type includes maxi-max, primary, residual and composite. A low frequency option supports imported profiles with a sampling rate lower than a few Hz.

Shock Response Spectrum (SRS) Synthesis & Control provides the means to control the measured SRS of the DUT to match a target SRS, the Required Response Spectrum (RRS). The necessary drive time history is synthesized from damped-sine or sine-beat wavelets. Damped Sine Parameters include frequency, amplitude, critical damping factor, and delay. Waveforms may be automatically synthesized from a user-specified SRS reference profile. The Transient Control option allows control using imported transient files. High frequency waveforms, Alarm and Abort tolerances may be applied to any active channel to provide an extra degree of safety for delicate test articles.

With a Waveform Editing for TTH and TWR feature, any existing signal may be treated as a profile, which can then be imported and defined as a control. For example, waveforms with any of multiple file types (e.g. ODS ATF/XML, CI-ODS, User defined ASCII, UFF ASCII, UFF Binary, CI-ODS, EDM View Project, TIM, RSP, and ASCII data formats) could be imported. For profile editing, waveforms with any sampling rates may be digitally re-sampled, rescaled, filtered, and different compensation techniques using a EDM—Waveform Editor tool. The tool might also have options for cropping, appending and inserting parts of waveforms, as well as capability for performing an AVD Plot (calculation of other two quantities among acceleration, velocity, or displacement when imported profile is of any quantity) and profile maximum (calculation of maximum expected acceleration, velocity and displacement, checked against shaker limits).

Sine Oscillator is a diagnosis tool with manual control of the sine output while the system displays various time signals and frequency spectra. Random excitation can be enabled as a checkup function. When the close-loop option is enabled, the Sine Oscillator is essentially a limited sine controller with more manual control functions.

Time Waveform Replication (TWR) provides precise, real-time, multi-channel control for long waveform duplication. TWR includes the Waveform Editor, a flexible importing and editing tools for long waveform signals. The

Recording option records time-stream data at the full sample rate on all input channels. Multiple waveform recordings can be available in the same test to automatically run, one after the other on the test specimen. The maximum number of points is subject to the internal flash memory space available for storing profile data (currently 3.7 GB), which corresponds to approximately 1 billion data points. At a sampling rate of 200 samples/second it can replicate a waveform of about 50 days.

With Non-Acceleration Control, a non-acceleration measurement quantity can be applied to the control signal. This provides an option of choosing from multiple quantities including force, sound pressure, and voltage to be controlled when appropriate sensors are used. Angular acceleration can be controlled in sine and random tests using the appropriate selection. The controller is also capable of using mixed displacement, velocity and acceleration sensors to synthesize a control signal in the acceleration domain.

Real-time sine reduction offers a solution to extend the number of measurement channels of a vibration controller system in a swept sine test. This software is run by a dynamic signal analyzer (DSA) system while an independent vibration controller controls the shaker. The sine reduction application calculates the same time and frequency functions as the controller, but using its own input signals. This function requires a COLA signal from the vibration controller system for instantaneous frequency, phase detection, and spectrum analysis.

The VCS software should also support a wide range of dynamic data acquisition and real-time processing functions including Fast Fourier Transform (FFT), Frequency Response Function (FRF), real-time filters, octave and sound level meters, order tracking, automated limit testing, transducer calibration and more.

### Test Safety

A variety of safety features can be used with the system to ensure reliable closed-loop vibration control—from pretest checks to abort checking, notching and controlled shutdown during a test. A check-only mode allows checking the connection of sensors and verifies the amplifier status before turning the drive output on. This pretest function is an extremely powerful tool for detecting possible set-up problems before your test is started. During closed-loop control the VCS software performs RMS and line-by-line abort checks, sigma clipping and drive limitation and continuously checks for open channels and overloads. The software carefully checks for open-loop conditions such as failure of a sensor connection and verifies proper response during the initial drive ramp-up. During every test, the shaker limits (peak acceleration, velocity, displacement), maximum drive voltage and sensor connection status are continuously monitored and will initiate an emergency shutdown in case of any deficiency.

With DSP centralized hardware architecture, the real-time measurement and control processes are all run on the front-end hardware; users can utilize all of the capabilities of the host computer for other tasks. This multi-tasking concept guarantees powerful and time efficient vibration testing, even with time critical tests. More importantly, it provides a unique and important safety feature: any computer or network failure will not affect the vibration control.

Many events can occur during the course of test operation, including certain response levels being reached, limits being exceeded, and user events such as Pause or Stop. Event-Action Rules define the response of the controller to these test events. Many actions are available as custom responses, such as sending an e-mail, send a digital output signal to the climate chamber or stopping the test.

### Integrated Control and Dynamic Signal Analysis

With appropriate software, the same controller hardware used for vibration control can also be used for dynamic signal analysis including machine monitoring, order tracking, modal analysis, and acoustic analysis. Long waveform data recording may be a built-in function. Multiple front-ends can work together to form one integrated system.

An optional hardware front-end could integrate monitoring of strain gages and thermocouples.

What is claimed is:

1. A method of simultaneously controlling and synchronizing vibration, temperature, and humidity in an environment test chamber over a specified reliability test duration, the method comprising:
integrating schedules for respective vibration, temperature, and humidity test parameters into a combined run schedule;
executing the combined run schedule using a single internal clock and a hardware processor to generate parameter control commands to the environment test chamber; and
receiving measurements from the environment test chamber synchronized to the single internal clock over the duration of the combined run schedule.

2. The method as in claim 1, wherein a vibration run schedule to be integrated into the combined run schedule specifies a sequence of vibration and shock tests to be performed at various specified times during a test.

3. The method as in claim 1, wherein a temperature run schedule to be integrated into the combined run schedule specifies test chamber temperatures and changes in temperature for various specified time periods during a test.

4. The method as in claim 1, wherein a humidity run schedule to be integrated into the combined run schedule specifies test chamber relative humidity and changes in relative humidity for various specified time periods during a test.

5. The method as in claim 1, wherein the received measurements from the environment test chamber are transmittable over a network with time synchronization based on the single internal clock.

6. A method of condition-based measurement and processing of vibration data obtained from a vibration, temperature and humidity controlled environment test chamber, the method comprising:
generating parameter control commands according to an integrated schedule of vibration, temperature, and humidity parameters and providing such control commands to the environment test chamber;
monitoring at least temperature and humidity conditions in the environment test chamber for one or more specified trigger conditions in any of monitored temperature and humidity and variables derived therefrom;
measuring and recording, upon identifying a specified trigger condition and starting within a required time interval, vibration data for a specified block of time; and
processing and analyzing the vibration data measured under each specified trigger condition encountered during a test.

7. The method as in claim 6, wherein the specified trigger condition is a pre-trigger condition, and monitoring temperature and humidity conditions includes analyzing temperature and humidity trends in order to anticipate likelihood of a trigger condition, measuring of vibration data being triggered upon the likelihood exceeding a specified threshold.

8. The method as in claim 6, wherein trigger conditions include any monitored temperatures, relative humidity, and variables derived therefrom exceeding a specified upper or lower limit.

9. The method as in claim 6, wherein trigger conditions also include any monitored acceleration, velocity or displacement values from vibration, or any variable derived therefrom, exceeding a specified limit.

10. The method as in claim 6, wherein trigger conditions also include vibration spectra exceeding specified limits at any frequency.

11. The method as in claim 6, wherein recording of vibration data upon identifying a trigger condition is repeated for each occurrence of a trigger unless recording is already active.

12. The method as in claim 11, wherein recording is limited to a specified maximum number of times for each type of trigger condition.

13. A method of analyzing vibration data obtained from a vibration, temperature and humidity controlled environment test chamber, the method comprising:
simultaneously measuring instantaneous values of temperature, humidity and vibration in the environment test chamber; and
processing, for each available condition of temperature and humidity or both, corresponding vibration data values to obtain condition-dependent vibration power spectra and averages.
